(19) United States
(12) Patent Application Publication
(10) Pub. No.: US 2012/0183740 A1
(43) Pub. Date: Jul. 19, 2012

(54) Plate attachment system

(75) Inventor: Ilya Tetelman, Holland, PA (US)

(73) Assignee: Granite Graphics, Inc., Holland, PA (US)

(21) Appl. No.: 13/317,188

(22) Filed: Oct. 11, 2011

Related U.S. Application Data
(60) Provisional application No. 61/391,857, filed on Oct. 11, 2010.

(51) Int. Cl. B32B 3/30; B32B 7/12; B32B 38/10; B32B 3/26; B32B 37/12; B32B 38/00

(52) U.S. Cl. 428/172; 156/60; 156/62; 216/33; 428/317.5; 428/354

(57) ABSTRACT

A plate attachment system and method comprising an image bearing plate, which may take the form of a cameo, substantially permanently adhered to a memorial substrate is disclosed. The system and method of the invention comprises a plate, an adhesive in contact with the plate, and a substrate in contact with the adhesive such that the plate is substantially permanently bonded to the substrate. The adhesive may comprise a very high bond acrylic foam tape or other suitable adhesive. The image may be engraved into the plate by an impact carving process. The plate attachment system is weather resistant, and may be installed from a kit in the field without the necessity of engaging skilled labor.

### CROSS REFERENCE TO RELATED APPLICATION

This application claims the benefit of and priority to U.S. Provisional Patent Application Ser. No. 61/391857, filed Oct. 11, 2010, the entirety of which is incorporated herein by reference.

### FIELD OF THE INVENTION

This invention relates generally to the attachment of a plate or plaques to a substrate, and more specifically to the attachment of a memorial plate to a gravestone or other memorial.

### BACKGROUND OF THE INVENTION

When constructing a memorial, it is common to adhere memorial plates or plaques to larger memorials, such as gravestones and other monuments. These memorial plates typically contain an image, such as a portrait of a deceased person, and are meant to enhance the appearance of a larger memorial. Methods currently available for attaching a memorial plate to a memorial include porcelain portraits, granite tile inserts, and bronze portrait castings.

Porcelain portrait products are currently some of the more popular among available products. Porcelain portrait products are generally light and able to be transported to the site of an installation, adhered to a substrate with adhesive, and comprise a color solution. Porcelain portrait products, however, are not durable or long-lasting when exposed to the rigors of an outdoor environment. In this regard, they use a heat-applied adhesive vinyl or similar substance adhered to various materials, most popularly porcelain. This heat-applied substance lacks permanent characteristics and, therefore, the image appearing on the plaque tends to fade after an extended period of time. This leaves the memorial to which it is applied with a white oval (or other shape) plaque bearing a faded or completely obscured image in the place of the previously existing portrait. Inasmuch as the image cannot be restored, the plaque must be replaced. However, costs of the removal and re-installation of the faded plaque for a replacement plaque are often expensive and left to be incurred by the deceased's survivors. Further, during the time of disrepair and re-installation, the memorial stands defaced, while the bereaved waits for a replacement. Moreover, at least some porcelain portrait products do not use permanent adhesives and/or techniques, thus making the memorial plate or plaque susceptible to detachment from the substrate.

Bronze portrait castings are more permanent in construction, but have other shortcomings. First, because of an offset technique used to portray the image in three dimensions, the final image often does not look like the original picture when transferred to the plaque. Also, bronze is a naturally decaying substance that almost immediately becomes covered with a layer of patina. In order to prevent the buildup of patina, many bronze casting manufacturers use a protective covering or coating to help keep the bronze from oxygen exposure. Even the most powerful and long-lasting formula only lasts several years, and, after the coating fades, the patina starts to appear. Further, as with porcelain portrait products, the adhesives and/or adhesive methods used for bronze castings are also unreliable, resulting in the detachment of the plaque from the substrate.

Granite tile inserts may employ carving technologies in an effort to provide granite plaque inserts that can be permanent and provide a recognizable image on the insert. However, granite tile inserts are typically very expensive to manufacture and difficult to install. Granite tile inserts use granite tiles that are polished on only one side, typically the front side upon which an image or other carving appears. The edges of the plaque insert remain unpolished. At least because the unpolished edges of the plaque should be protected from the rigors of an outdoor environment, and because of the unattractiveness of unpolished edges, granite tile inserts rely upon a cavity in the shape of the outline of the plaque insert being carved out of the surface of the monument substrate, which cavity is then suitable for receiving the plaque insert. When inserted into the cavity, the unpolished edges of the plaque insert are protected from the outdoor environment and hidden from view.

With the granite tile insert products, the preparation process of carving out a cavity in the surface of the monument substrate is generally expensive, requires skilled labor, and sometimes costs more than the actual plaque insert product itself. The carving process is also inconvenient, expensive, and time consuming for installers because, in certain instances, the cavity carving process is carried out in the field after the monument substrate is installed. Moreover, the expense and time consuming installation are distinct product disadvantages which impede the sales process.

For at least the foregoing reasons, there is a present need for a memorial plate or plaque system and attachment method which provides an attractive memorial plate or plaque having a permanently engraved image, which resists fading under the rigors of an outdoor environment, and where the memorial plate or plaque can be easily, affordably, and permanently adhered to a memorial substrate.

### SUMMARY OF THE INVENTION

The present invention provides a system and method for attaching a plate or plaque to a substrate. The system and method of the present invention may include the steps of attaching a first side of an adhesive to a plate and attaching a second side of the adhesive to a substrate. The plate or plaque may be a memorial plate or plaque, the substrate may be a memorial, and the adhesive may be a very high bond acrylic foam tape or other suitable high bond adhesive. The system may allow an attractive memorial plate to easily, affordably, and permanently adhere to a memorial.

In addition, the plate may bear an image which resists the rigors of an outdoor environment, weather, sunlight and the like. To produce such an image suitable carving technologies may be employed. Such carving technologies produce a substantially permanent and true image of the subject portrayed on the plate, and produce an image which is highly resistant to wear and outdoor environments. Typical laser engraving and etching processes are not sufficient.

The present invention may further provide a system which comprises a plate or plaque, an adhesive in contact with the plate, and a substrate in contact with the adhesive. The plate may take the form of a cameo portion, wherein the plate or cameo portion comprises an image which appears on the surface of the plate or cameo portion. The adhesive may comprise a very high bond acrylic foam tape or other adhesive suitable for permanent bonding of the plate to the substrate (which substrate may take the form of a memorial) and withstanding an outdoor environment.

The present invention further provides a method for attaching a first side of an adhesive to a plate and attaching a second side of the adhesive to a substrate where the plate is a cameo comprising an image, where the adhesive is a very high bond acrylic foam tape, and where the substrate is a memorial.

The plate attachment system of the present invention is not susceptible to the rigors of an outdoor environment, is weather resistant, and deters vandalism which is common to monuments of all types located in public outdoor settings.

Moreover, the plate attachment system and method of the present invention may be installed from a kit in the field without the necessity of engaging skilled labor. Such a kit may include a plate, with or without an image etched thereon, the adhesive used in the present invention. The kit may also include installation instructions, templates and other materials necessary or useful for installation of the plate on the substrate of the present invention. For example, an installation template may assist an unskilled installer to properly align the plate of the present invention on the substrate so that the plate is properly centered and otherwise positioned on the substrate before the plate is permanently adhered to the substrate.

### BRIEF DESCRIPTION OF THE DRAWINGS

FIG. 1 depicts a perspective view of one embodiment of the plate attachment system of the present invention.

FIG. 2 depicts a front elevation view of the plate attachment system of FIG. 1.

FIG. 3 depicts a side elevation view of the plate attachment system of FIG. 1.

FIG. 4 depicts an embodiment of a plate of the instant invention attached to a memorial or headstone substrate.

FIG. 5 depicts an exploded perspective view of the plate attachment system of FIG. 1 prior to the assembly of the various components of the system of the present invention.

FIG. 6 depicts a front elevation view of the assembled plate attachment system of FIG. 5.

FIG. 7 depicts a side elevation view of the assembled plate attachment system of FIG. 5.

FIG. 8 depicts a perspective sectional view of the assembled plate attachment system of FIG. 6.

FIG. 8A depicts a detailed view of the elements depicted in the perspective sectional view shown in FIG. 8 of the plate attachment system of FIG. 6.

FIG. 9A depicts a perspective view of the plate comprising an image of the plate attachment system of FIG. 5.

FIG. 9B depicts a side elevation view of the plate of FIG. 9A.

FIG. 9C depicts a front elevation view of the plate of FIG. 9A.

FIG. 9D depicts the rear elevation view of the plate of FIG. 9A, where the rear surface of the plate is substantially smooth.

FIG. 10A depicts a perspective view of the plate comprising an image of the plate attachment system of FIG. 5.

FIG. 10B depicts a side elevation view of the plate of FIG. 10A.

FIG. 10C depicts a front elevation view of the plate of FIG. 10A.

FIG. 10D depicts the rear elevation view of the plate of FIG. 10A, where the rear surface the plate comprises saw cuts.

FIG. 11A depicts the plate of FIGS. 9A and 10A having Standard Eased Beveled edges.

FIG. 11B depicts the plate of FIGS. 9A and 10A having a Beveled edge.

FIG. 11C depicts the plate of FIGS. 9A and 10A having a Pencil Round Beveled edge.

FIG. 11D depicts the plate of FIGS. 9A and 10A having a top Beveled edge.

FIG. 11E depicts the plate of FIGS. 9A and 10A having a Half Bullnose Beveled edge.

FIG. 11F depicts the plate of FIGS. 9A and 10A of approximately a 1¼″ height with a Double Bevel where a polished straight edge is beveled on top and bottom as one embodiment.

FIG. 11G depicts the plate of FIGS. 9A and 10A of approximately a 1¼″ height with a Full Bullnose Bevel where the side of the plate now has a radius of ⅝″ as one embodiment.

FIG. 11H depicts the plate of FIGS. 9A and 10A of approximately a 1¼″ height with an Ogee Bevel as one embodiment.

FIG. 12A depicts a perspective view of the plate of FIGS. 9A and 10A having the beveled edge depicted in FIG. 11D.

FIG. 12B depicts a side elevation view of the plate of FIG. 12A.

FIG. 12C depicts a front elevation view of the plate of FIG. 12A.

FIG. 12D depicts a rear elevation view of the plate of FIG. 12A.

FIG. 13A depicts a perspective view of the plate of FIGS. 9A and 10A having the radius edge depicted in FIG. 11E.

FIG. 13B depicts a side elevation view of the plate of FIG. 13A.

FIG. 13C depicts a front elevation view of the plate of FIG. 13A.

FIG. 13D depicts a rear elevation view of the plate of FIG. 13A.

FIG. 14A depicts a perspective view of the plate of FIGS. 9A and having the beveled edge depicted in FIG. 11F.

FIG. 14B depicts a side elevation view of the plate of FIG. 14A.

FIG. 14C depicts a front elevation view of the plate of FIG. 14A.

FIG. 14D depicts a rear elevation view of the plate of FIG. 14A.

FIG. 15A depicts a perspective view of the plate of FIGS. 9A and 10A having the radius edge depicted in FIG. 11G.

FIG. 15B depicts a side elevation view of the plate of FIG. 15A.

FIG. 15C depicts a front elevation view of the plate of FIG. 15A.

FIG. 15D depicts a rear elevation view of the plate of FIG. 15A.

FIG. 16A depicts a perspective view of the plate of FIGS. 9A and 10A having the Ogee edge depicted in FIG. 11H.

FIG. 16B depicts a side elevation view of the plate of FIG. 16A.

FIG. 16C depicts a front elevation view of the plate of FIG. 16A.

FIG. 16D depicts a rear elevation view of the plate of FIG. 16A.

### DESCRIPTION OF THE EMBODIMENTS OF THE INVENTION

Understanding of the present invention will be facilitated by consideration of the following detailed description of embodiments of the present invention taken in conjunction with particular embodiments as described in the accompanying written description and figures. It is to be understood that the figures and descriptions of the present invention have been simplified to illustrate elements that are relevant for a clear understanding of the present invention.

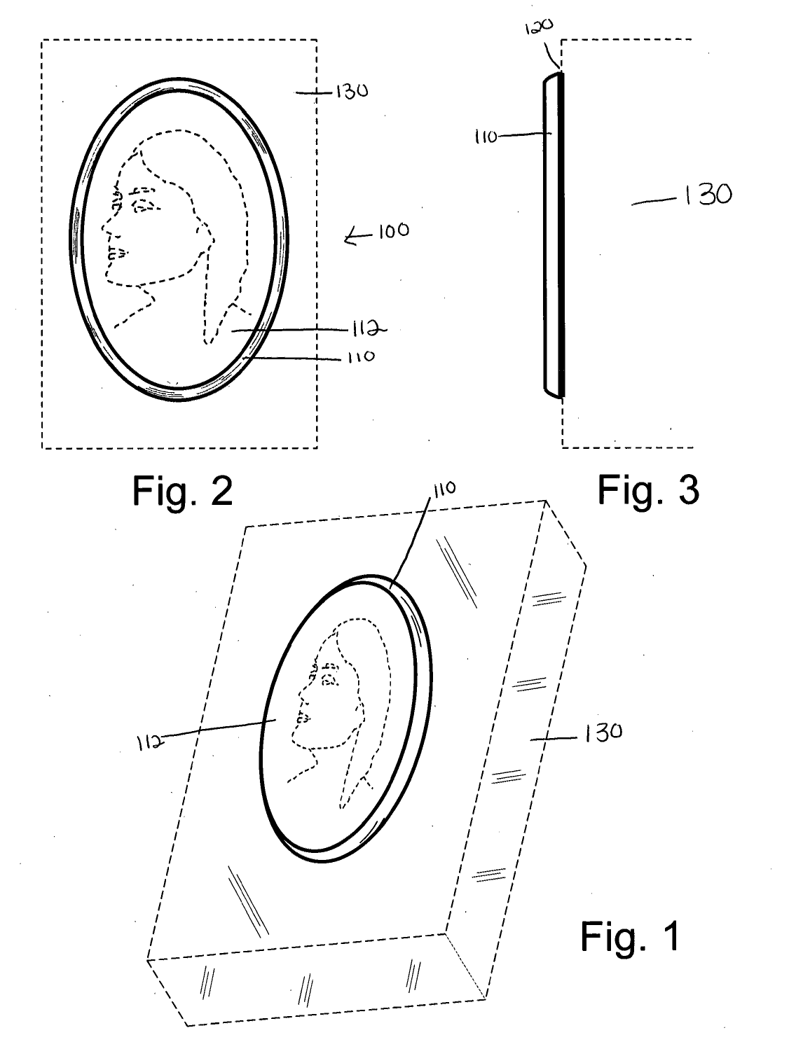

Referring generally now to FIG. 1 through FIG. 16D in which like reference characters refer to like parts throughout the several views thereof, a plate attachment system 100 is provided according to the present invention.

FIG. 1 depicts a perspective view of one embodiment of plate attachment system 100 where the broken lines indicate substrate 130. This figure also depicts a plate 110 which comprises an image 112, wherein plate 110 is attached to the substrate 130.

FIG. 2 depicts the front elevation view of the plate attachment system 100 where the broken lines indicate substrate 130. This figure also depicts plate 110 which comprises image 112 attached to substrate 130.

FIG. 3 depicts a side elevation view of the of the plate attachment system 100, where plate 110 is attached to substrate 130 by an adhesive 120.

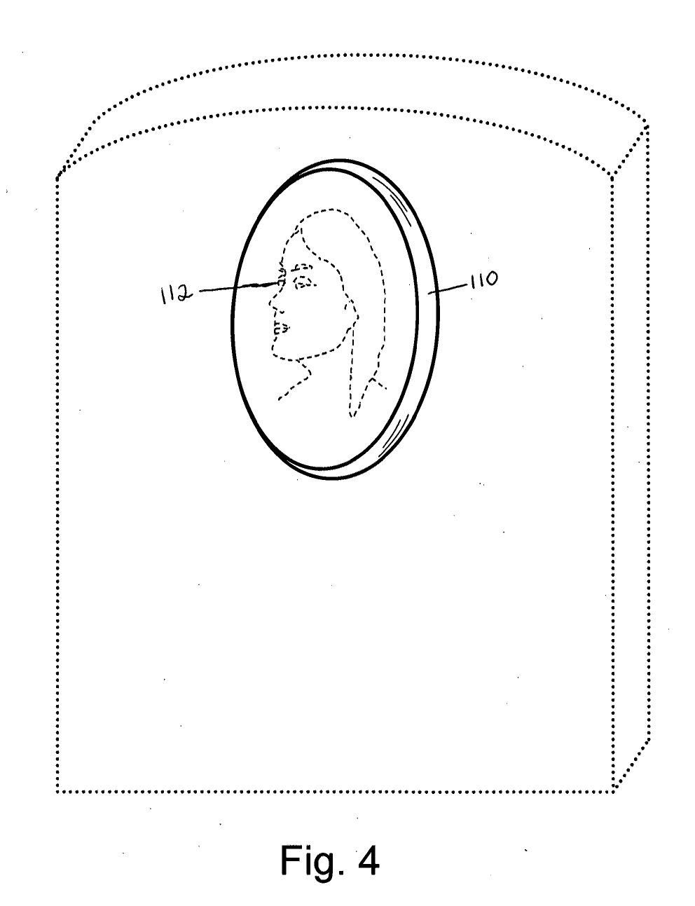

FIG. 4 depicts one embodiment where plate 110 comprising image 112 is attached to a memorial or gravestone as depicted by the broken lines.

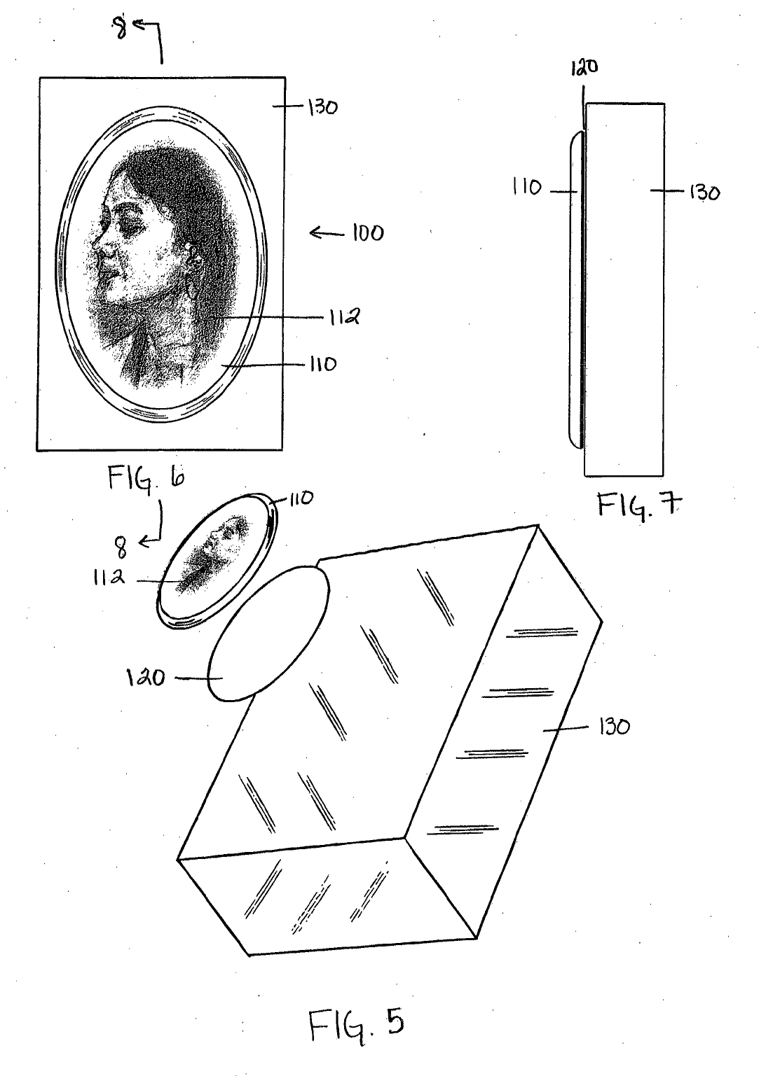

FIG. 5 depicts a perspective exploded view of attachment system 100. More specifically, this figure depicts plate 110, adhesive 120, and substrate 130 prior to assembly. When the plate attachment system is assembled, plate 110 is adhered to substrate 130 by adhesive 120. Adhesive 120 may comprise a permanent double-sided tape cut to the approximate size of plate 110 to prevent any significant leakage and moisture exposure which may weaken the bond between substrate 130 and plate 110. Once adhesive 120 is adhered to plate 110, plate 110 may be adhered to substrate 130. Alternatively, adhesive 130 may be applied to substrate 130 and then plate 110 may be adhered to adhesive 120.

Substrate 130 may comprise any object with a substantially flat surface for receiving adhesive 120 and plate 110. In one embodiment, substrate 130 is a memorial. A memorial can be any object for preserving remembrance, such as a gravestone, monument, mausoleum wall, niche plate, niche cover, or crypt plate.

Plate 110 may be any object with a substantially flat surface for adhering to adhesive 120 and substrate 130. In one embodiment, the plate 110 may be a cameo comprising an image 112 such as image 112 shown in FIG. 5 and FIG. 6. Plate 110 may also carry no image or may carry any image that can be engraved or otherwise transferred or formed onto plate 110. Plate 110 may be oval or any other desired shape, and may be made of any material suitable for the intended purpose of the application.

In one embodiment, plate 110 is made from black granite and is polished on all sides except the side that is attached to substrate 130.

Since substrate 130 may be located outdoors, adhesive layer 120 may be chosen to be impervious and/or suitably resistant to any weather, freezing and thawing conditions, and/or vandalism. Many adhesives are not ideal for such situations. For example, some allow moisture to seep into cracks and other openings that, when frozen, can crack and shatter the finished product. Further, some adhesives may stiffen in cold and freezing temperatures, rendering them less effective and susceptible to vandalism. Further, some adhesives may soften in high temperatures, extreme heat, and/or extended exposure to the sun, therein weakening the bond between plate 110 and substrate 130. Thus, the permanency of the adhesive bond may be compromised.

In one embodiment, adhesive 120 may comprise a very high bond (“VHB”) adhesive. One such adhesive is 4905 VHB Acrylic Foam (clear) Tape available from the 3M Corporation. VHB is one of the most permanent of adhesives available. Other variations of VHB by 3M Corporation and 3M Corporation's competitors also may be used for the adhesive 120.

While in one embodiment adhesive 120 may comprise a single layer of adhesive 120 covering substantially the entire surface of rear side 116 of plate 110, adhesive 120 may also be applied in other manners. For example, a ring of adhesive 120 may be applied around the peripheral edge of surface 116. This peripheral configuration of adhesive 120 will tend to create a barrier which prevents moisture from forming or otherwise collecting between plate 110 and substrate 130.

In another embodiment, adhesive 120 may be formed from strips of adhesive 120, thus creating one large adhesive layer 120. This approach may work because VHB has a conjoining property, and, over time, all strips forming adhesive 120 will bond together to form one contiguous adhesive layer 120. However, it should be noted that, in some embodiments of the present invention, failure to sufficiently cover surface 116 of plate 110 with a suitable adhesive 120, may result in ultimate failure of the bond between plate 110 and substrate 130.

FIG. 6 depicts a front elevation view of assembled system 100. In this figure, plate 110 comprises image 112, and is attached to substrate 130 by adhesive 120.

FIG. 7 depicts a side view of assembled system 100 of FIG. 6, where plate 110 is attached to substrate 130 by adhesive 120.

FIG. 8 depicts a perspective sectional view of assembled system 100. FIG. 8A provides an enlarged detailed view of the elements depicted in the perspective sectional view of assembled system 100 provided in FIG. 8. More specifically, FIG. 8A depicts plate 110 adhered to front side 122 of adhesive 120, and substrate 130 adhered to rear side 124 of adhesive 120.

In one embodiment, plate 110 is approximately ⅜″ thick and is made of absolute black or similar quality granite. Plate 110 may comprise beveled or other formed edges around the sides of plate 110. Further, a high gloss polish may be applied to the top surface and around the edges of plate 110. Front side 114 of plate 110 may be flat and fully polished to a high gloss. In one embodiment, plate 110 may be oval in overall shape, but may be any shape, including a circle, square, rectangle, heart, or octagon, or other desired shape.

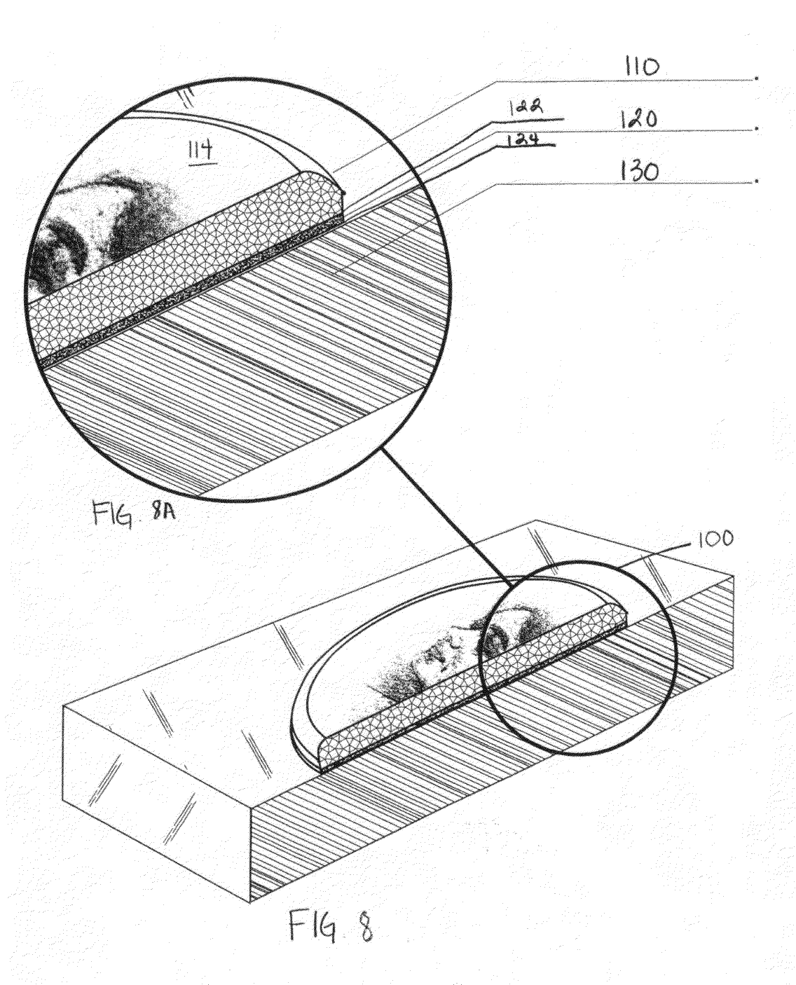

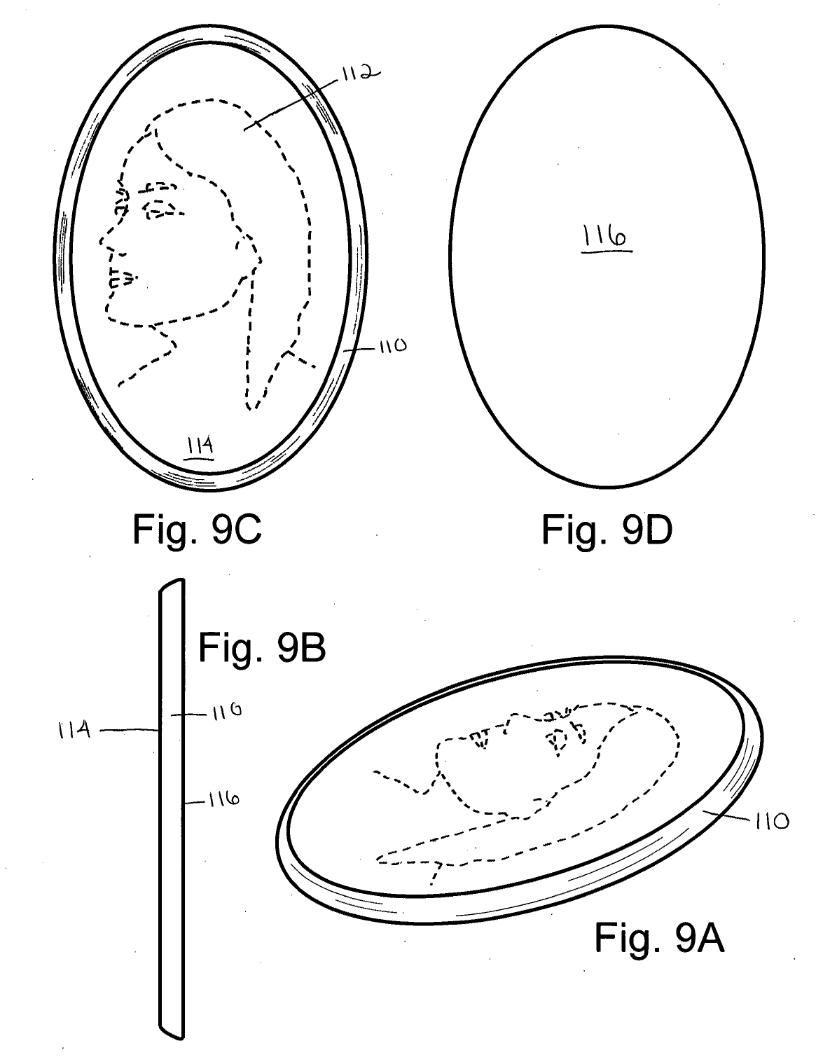

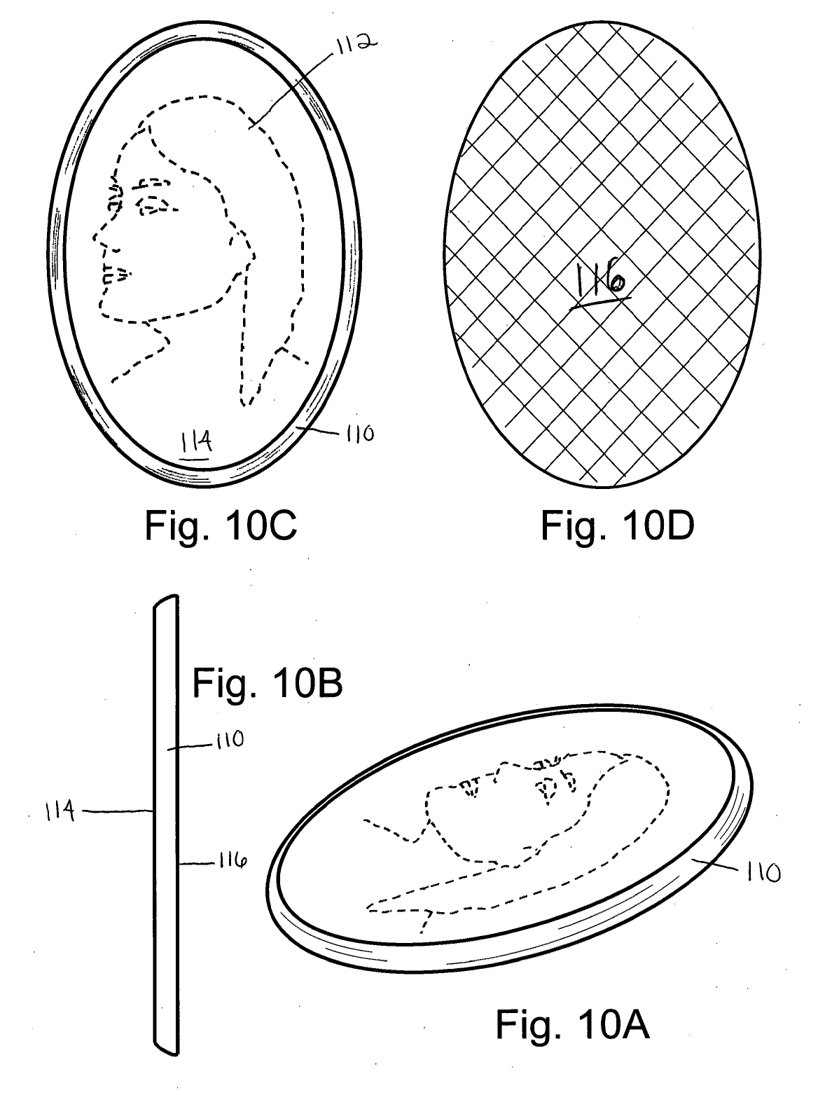

FIG. 9A and FIG. 10A depict a perspective view of plate 110, where plate 110 is a cameo comprising an image 112. In one embodiment, image 112 engraved into surface 114 of plate 110, wherein surface 114 comprises a substantially flat, polished surface.

Image 112 may comprise a portrait of at least one person, but may comprise any image. In one embodiment, engraving of image 112 onto plate 110 may be accomplished by a high quality, photo-replicating carving or engraving technology. This carving technology carves away at the polished layer of surface 114 of plate 112, to create an image from contrasting pixels that may become exposed when carved, in relation to the black polish.

This carving technology works in a similar fashion to how an ink printer works on paper, except instead of adding a layer of ink to the paper as an printer does, the technology removes the layer of black surface polish on the surface to be etched. As a printer adds pixels and is reliant on resolution to create an image, so does this carving process. The natural color of granite is a light grey, because of the jagged reflective crystals that protrude in various directions. The polished surface is finished to a black shine and crystals are leveled to the flat surface. When small pixels of information are released from the polish, the exposed crystals of the natural granite reflect light differently, thus creating the perception of light grey color to create contrast in the image.

However, in other embodiments of the invention, the engraving of image 112 on plate 110 may be carried out by other methods that achieve a lesser quality image. Such techniques may include Laser Engraving/Etching, Acid Etching, hand carved artistic engravings, and any diamond tipped or similarly powered engraving machine capable of creating raster images on plate 110.

Further, image 112 may be altered in preparation for engraving. For example, certain features of an original image to be applied to plate 110 may be enhanced and backgrounds may be optimized to create an ideal image 112 for plate 110.

FIG. 9B depicts a side view of plate 110 having a front side 114 and a rear side 116. FIG. 9C depicts front side 114 of plate 110 having image 112 thereon. FIG. 9D depicts rear side 116 of plate 110 wherein the surface of rear side 116 of the plate 110, though substantially unpolished and untreated, has a substantially smooth back.

FIG. 10B depicts a side view of the plate 110 having a front side 114 and a rear side 116. FIG. 10C depicts front side 114 of plate 110. FIG. 10D depicts rear side 116 of plate 110 wherein the surface of rear side 116 comprises saw cuts therein and a substantially smooth surface between such saw cuts. The saw cuts in the surface of side 116 may create a base to which adhesive 120 is applied.

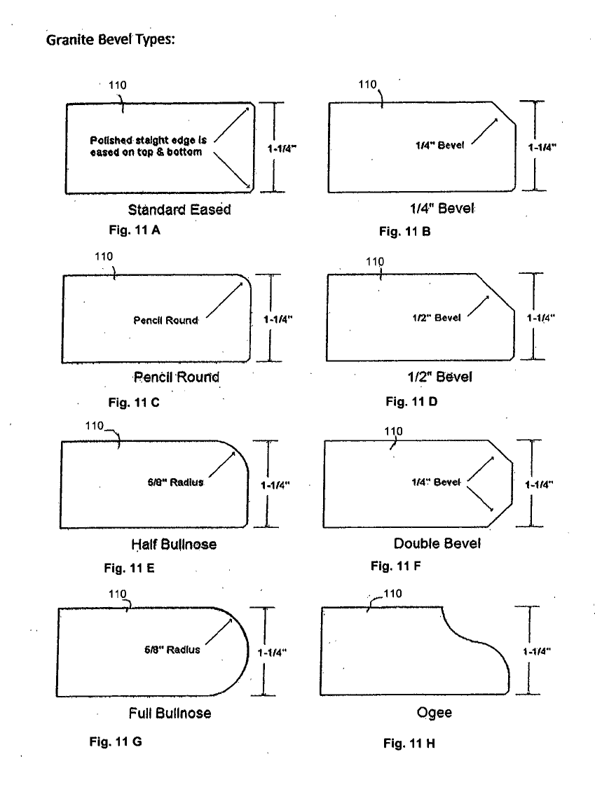

FIGS. 11A through 11H depict various types of edge shapes which may be incorporated into plate 110. FIG. 11A depicts an embodiment of plate 110 having approximately a 1¼″ height, and comprising Standard Eased Beveled edges on plate 110's top and/or bottom edges. FIG. 11 B depicts an embodiment of plate 110 having approximately a 1¼″ height, and comprising a ¼″ Beveled edge on the plate 110's top edge. FIG. 11C depicts an embodiment of plate 110 having approximately a 1¼″ height, and comprising a Pencil Round Beveled edge on plate 110′s top edge. FIG. 11D depicts an embodiment of plate 110 having approximately a 1¼″ height, and comprising a ½″ Beveled edge on plate 110's top edge. FIG. 11E depicts an embodiment of plate 110 having approximately a 1¼″ height, and comprising a Half Bullnose Beveled edge having a radius of approximately ⅝″ on plate 110's top edge. FIG. 11F depicts an embodiment of plate 110 having approximately a 1¼″ height, and comprising a Double Beveled edge having a polished straight edge on plate 110's top and/or bottom edges. FIG. 11G depicts an embodiment of plate 110 having approximately a 1¼″ height, and comprising a Full Bullnose Beveled edge where the side of plate 110 has a radius of approximately ⅝″. FIG. 11H depicts an embodiment of plate 110 having approximately a 1¼″ height, and comprising an Ogee Beveled edge.

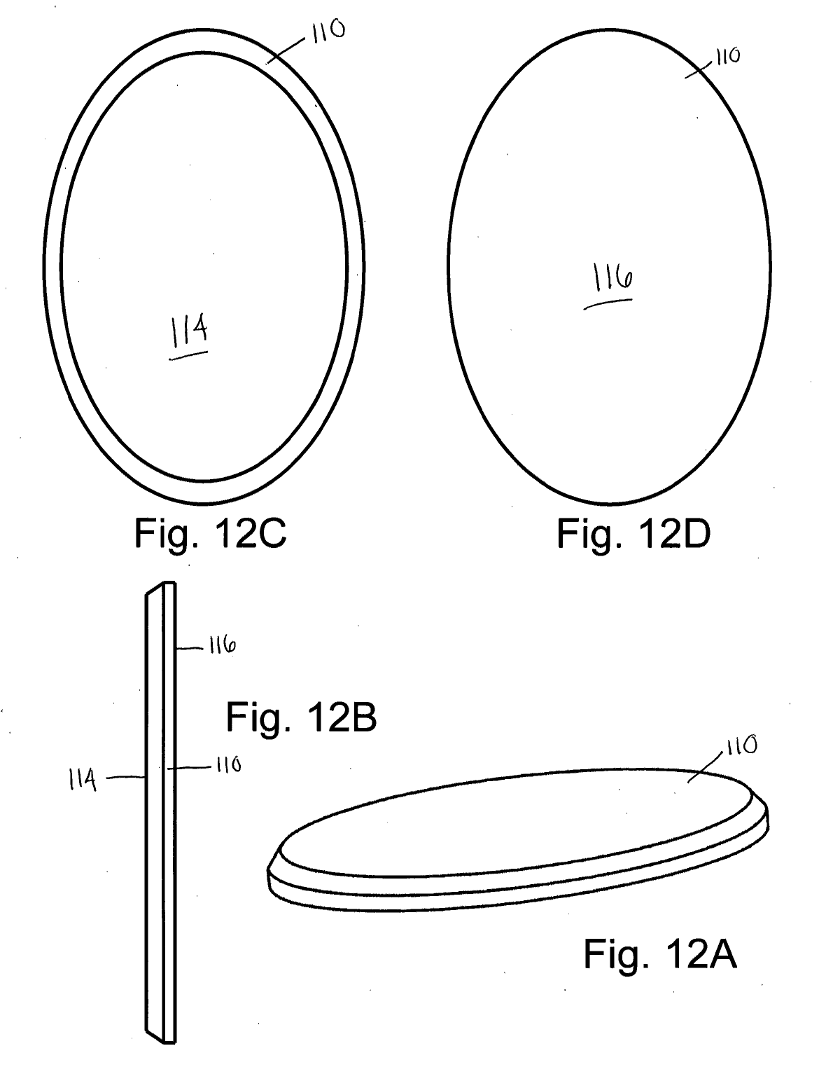

FIG. 12A depicts a perspective view of plate 110 having the ½″ Beveled edge depicted in FIG. 11D. FIG. 12B depicts a side elevation view of plate 110 having a ½″ Beveled edge, together with front side 114 and rear side 116. FIG. 12C depicts a front elevation view of plate 110 having a ½″ Beveled edge and front side 114. FIG. 12D depicts a rear elevation view of plate 110 having a ½″ Beveled edge and rear side 116.

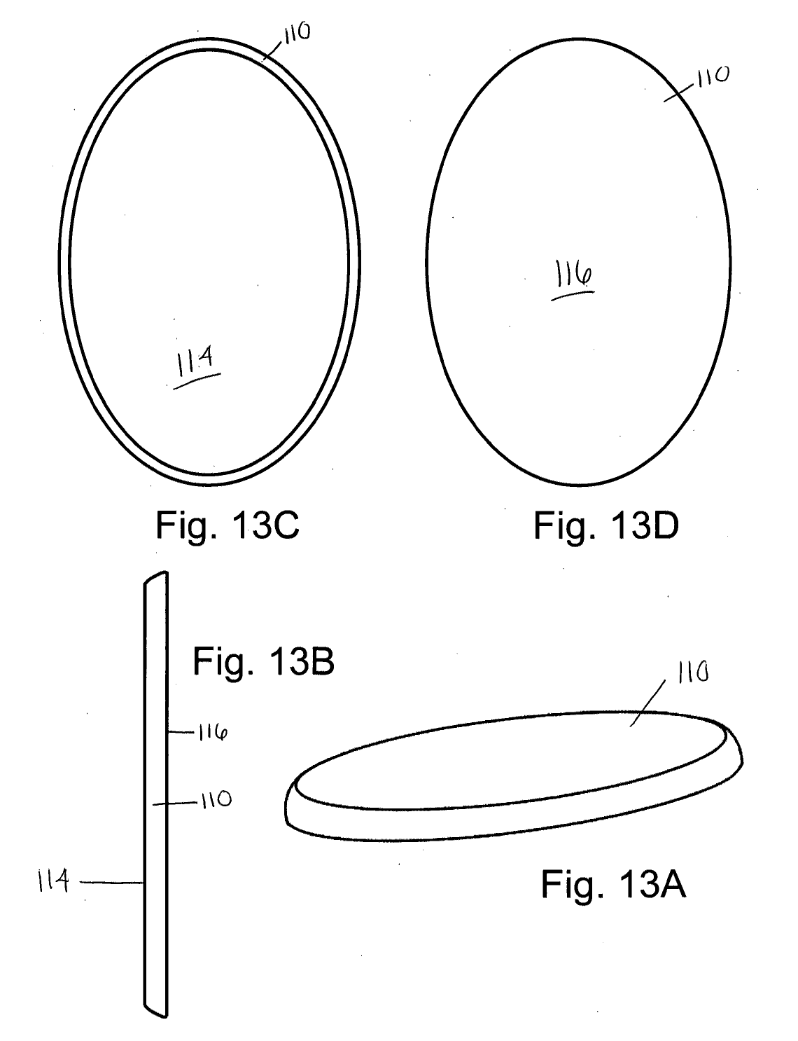

FIG. 13A depicts a perspective view of plate 110 having the Half Bullnose Beveled edge as depicted in FIG. 11E. FIG. 13B depicts a side elevation view of plate 110 having a Half Bullnose Beveled edge, together with front side 114 and rear side 116. FIG. 13C depicts a front elevation view of plate 110 having a Half Bullnose Beveled edge and front side 114. FIG. 13D depicts a rear elevation view of plate 110 having a Half Bullnose Beveled edge and rear side 116.

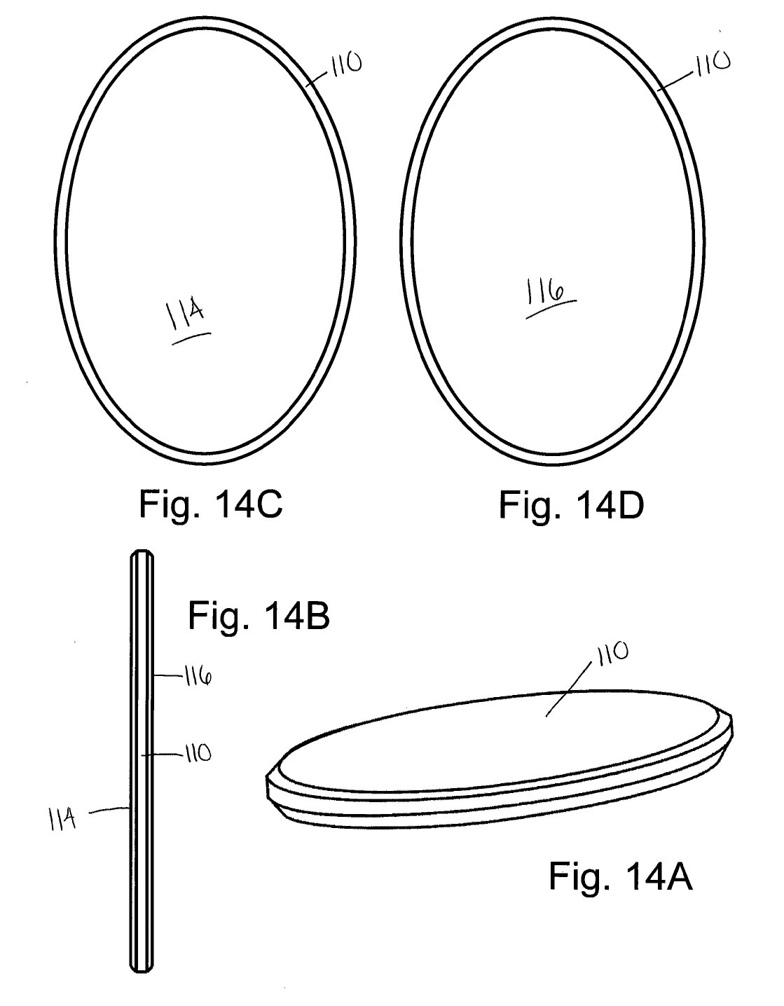

FIG. 14A depicts a perspective view of plate 110 having the Double Beveled edge depicted in FIG. 11F. FIG. 14B depicts a side elevation view of plate 110 having a Double Beveled edge, together with front side 114 and rear side 116. FIG. 14C depicts a front elevation view of plate 110 having a Double Beveled edge and front side 114. FIG. 14D depicts a rear elevation view of plate 110 having a Double Beveled edge and rear side 116.

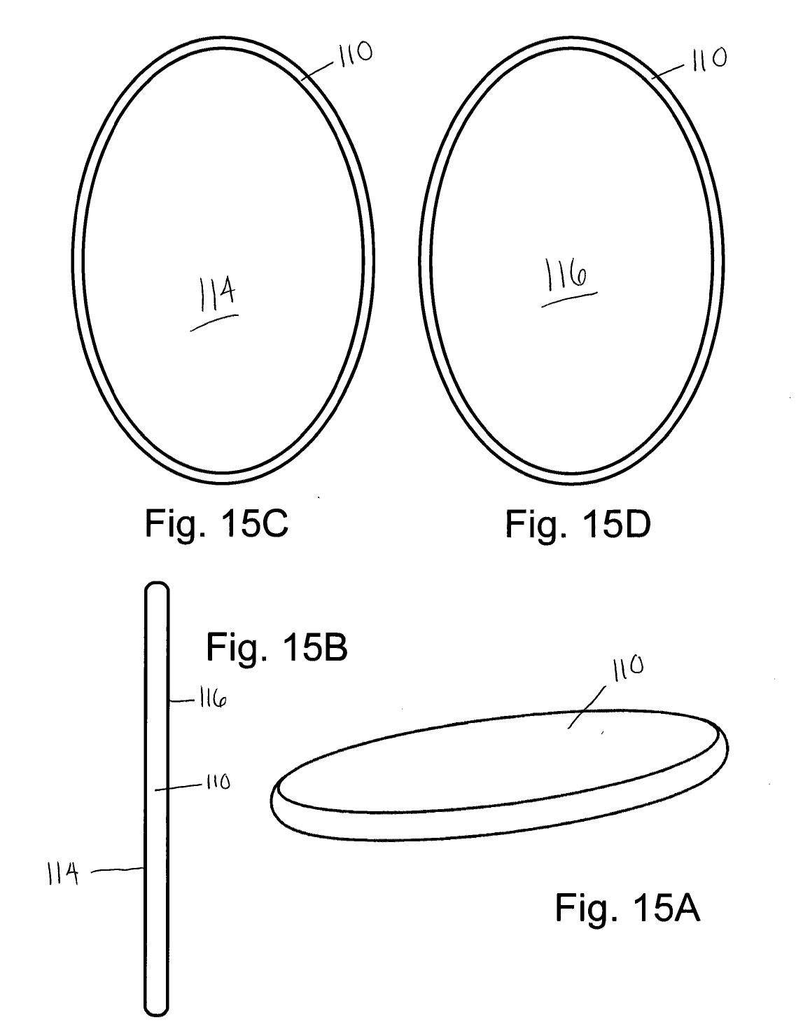

FIG. 15A depicts a perspective view of plate 110 having a Full Bullnose Beveled edge depicted in FIG. 11G. FIG. 15B depicts a side elevation view of plate 110 having a Full Bullnose Beveled edge, together with front side 114 and rear side 116. FIG. 15C depicts a front elevation view of plate 110 having a Full Bullnose Beveled edge and front side 114. FIG. 15D depicts a rear elevation view of plate 110 having a Full Bullnose Beveled edge and rear side 116.

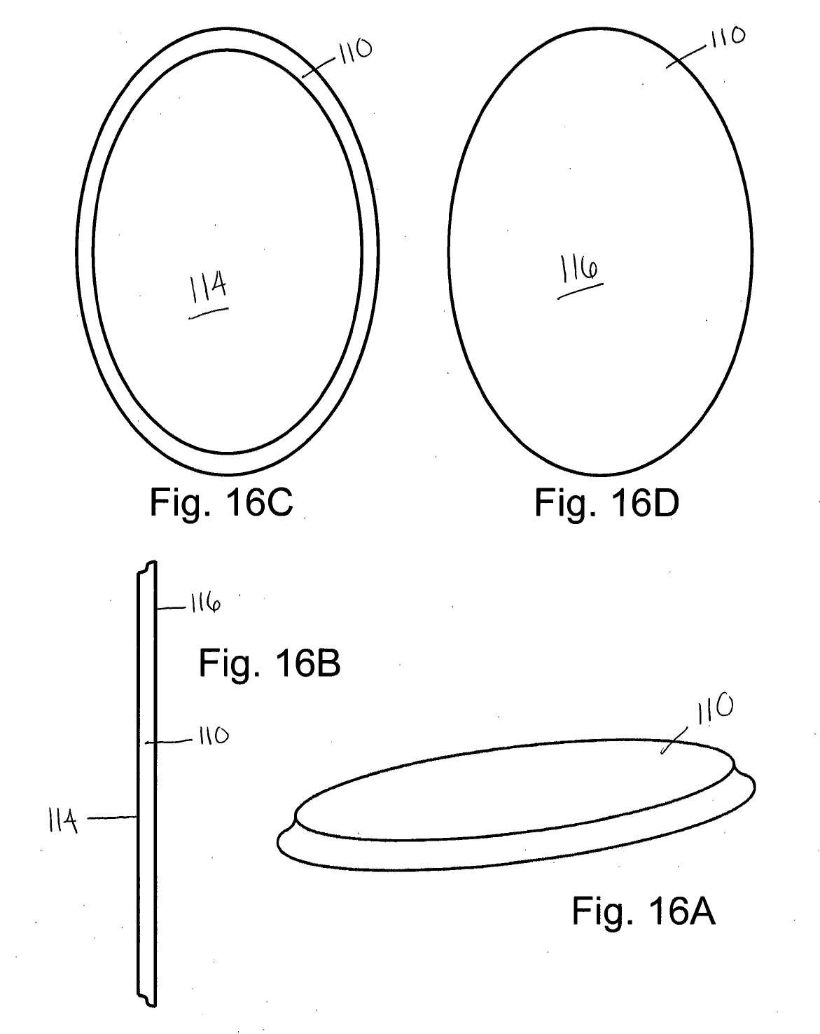

FIG. 16A depicts a perspective view of plate 110 having the Ogee Beveled edge depicted in FIG. 11H. FIG. 16B depicts a side elevation view of plate 110 having an Ogee Beveled edge, together with front side 114 and rear side 116. FIG. 16C depicts a front elevation view of plate 110 having an Ogee Beveled edge and front side 114. FIG. 16D depicts a rear elevation view of plate 110 having an Ogee Beveled edge and rear side 116.

Modifications may be made to the embodiments described above without departing from the broad inventive concept thereof. Having described some embodiments of the invention, additional embodiments, adaptations, variations, modifications, and equivalent arrangements will be apparent to those skilled in the art. These and other embodiments will be understood to be within the scope of the appended claims and apparent to those skilled in the art.

We claim:

1. A system comprising:
a plate;
an adhesive in contact with said plate; and
a substrate in contact with said adhesive;
wherein said plate is substantially permanently bonded to said substrate.

2. The system of claim 1, wherein an image is engraved or otherwise etched into a surface of said plate.

3. The system of claim 1, wherein said plate comprises a cameo.

4. The system of claim 1, wherein said adhesive comprises a very high bond acrylic foam tape.

5. The system of claim 1, wherein said substrate comprises a memorial.

6. The system of claim 2, wherein said image is engraved into said plate by an impact carving process.

7. A method for attaching a plate to a substrate, said method comprising:
attaching a first side of an adhesive to a plate; and
attaching a second side of said adhesive to a substrate;
wherein said plate is substantially permanently bonded to said substrate.

8. The method of claim 7, wherein an image is engraved or otherwise etched into a surface of said plate.

9. The method of claim 7, wherein said plate comprises a cameo.

10. The method of claim 7, wherein said adhesive comprises a very high bond acrylic foam tape.

11. The method of claim 7, wherein said substrate comprises a memorial.

12. The method of claim 8, wherein said image is engraved into said plate by an impact carving process.

13. An assembly kit for attaching a plate to a substrate, said kit comprising:
a plate;
an adhesive for adhering said plate to said substrate;
wherein said plate may be substantially permanently bonded to said substrate.

14. The kit of claim 13, wherein an image is engraved or otherwise etched into a surface of said plate.

15. The kit of claim 13, wherein said plate comprises a cameo.

16. The kit of claim 13, wherein said adhesive comprises a very high bond acrylic foam tape.

17. The kit of claim 13, wherein said substrate comprises a memorial.

18. The kit of claim 14, wherein said image is engraved into said plate by an impact carving process.

19. The kit of claim 13, further comprising plate installation instructions.

20. The kit of claim 13, further comprising an installation template.
